(19) United States
(12) Patent Application Publication
(10) Pub. No.: US 2011/0133696 A1
(43) Pub. Date: Jun. 9, 2011

(54) ACCESSORY AND CHARGING SYSTEM FOR A RECHARGEABLE HAND-HELD ELECTRICAL DEVICE

(76) Inventors: David Leigh Scrimshaw, Victoria (AU); Benjamin Luke Van der Linde, Victoria (AU); Paul Francis Connor, Victoria (AU); Paul Miller, Victoria (AU)

(21) Appl. No.: 12/994,528

(22) PCT Filed: May 27, 2009
(86) PCT No.: PCT/AU2009/000667

§ 371 Date: Feb. 7, 2011

(30) Foreign Application Priority Data
May 28, 2008 (AU) 2008902678

(51) Int. Cl. H02J 7/00

(52) U.S. Cl. 320/115

(57) ABSTRACT

The present invention relates to rechargeable hand-held electrical devices, chargers and accessories for use therewith. The present invention provides an accessory and charging system for a rechargeable hand-held electrical device. The system includes an electrical device, an accessory and a charger. The electrical device includes a first connecting portion, the charger includes a second connecting portion and the accessory includes a third connecting portion. The first connecting portion of the electrical device is configured to mate with the second connecting portion for enabling the charger to recharge the electrical device. The first connecting portion of the electrical device is also configured to mate with the third connecting portion for enabling the electrical device to supply power to the accessory. Accordingly, the system provides a hand-held electrical device which can serve at least one primary function as well as an accessory which, when attached to the device, can serve at least one secondary function whilst requiring only a single power storage means associated with the device and a single charger to charge the device. In one form, the electrical device is an electrical appliance, such as a hand held power tool, and in another form the accessory includes an electric light.

### FIELD OF THE INVENTION

The present invention relates to rechargeable hand-held electrical devices, chargers and accessories for use therewith.

### BACKGROUND TO THE INVENTION

Rechargeable hand-held electrical devices can include a rechargeable power storage means in the form of a rechargeable battery. Such devices may employ a charger to recharge the power storage means when, as a result of use of the device, the charge in the power storage means has been drawn down. Examples of such rechargeable hand-held electrical devices include hand held electrical screw-drivers, drills and other appliances.

The rechargeable power storage means of rechargeable hand-held electrical devices are typically bulky, heavy and expensive. Accordingly, having multiple types of rechargeable hand-held electrical device serving multiple distinct functions, each with their own rechargeable power storage means, is expensive, requires a large amount of space for storage and is heavy and difficult to transport. Accordingly, it would be advantageous to have a system which provides the functionality of multiple hand-held electrical devices serving multiple distinct functions without requiring multiple distinct rechargeable power storage means for each device.

### SUMMARY OF THE INVENTION

Accordingly, in a first aspect, the present invention provides an accessory and charging system for a rechargeable hand-held electrical device, the system including an electrical device, an accessory and a charger, wherein the electrical device includes a first connecting portion, the charger includes a second connecting portion and the accessory includes a third connecting portion, wherein the first connecting portion of the electrical device is configured to mate with the second connecting portion for enabling the charger to recharge the electrical device and with the third connecting portion for enabling the electrical device to supply power to the accessory.

The above aspect is advantageous in that the system provides a rechargeable hand-held electrical device that has a connecting portion that enables the device to be mounted to a charger to recharge the device when, as a result of use of the device, the electrical power stored in the device has been drawn down. The above aspect is also advantageous in that the same connecting portion used to mate the device to the charger to allow the charger to recharge the device can also be used to mate the device with an accessory requiring electrical power in a manner that enables the device to supply electrical power to the accessory. Accordingly, the system provides a hand-held electrical device which can serve at least one primary function as well as an accessory which, when attached to the device, can serve at least one secondary function whilst requiring only a single power storage means associated with the device and a single charger to charge the device. Furthermore, by enabling the charger and the accessory to be connected to same connecting portion of the device the device can be produced with a minimal amount of connecting portions to satisfy the requirement of being able to connect to both the charger and the accessory in order for the charger to recharge the power storage means of the device and for the device to supply power to the accessory, respectively.

In one form, the first, second and third connecting portions include first, second and third electrical contact respectively and the first electrical contact is configured to engage with the second electrical contact for conducting electrical power from the charger to the electrical device and with the third electrical contact for conducting electrical power from the electrical device to the accessory.

In another form, the first, second and third connecting portions include first, second and third mechanical interfaces respectively wherein the first mechanical interface is configured to engage with the second mechanical interface for connecting the charger and the electrical device and to engage with the third mechanical interface for connecting the electrical device and the accessory.

In yet another form, the first and second mechanical interfaces include first and second latching portions respectively wherein the first latching portion is configured to engage the second latching portion.

In yet another form, the first and third mechanical interfaces include first and third latching portions respectively wherein the first latching portion is configured to engage the third latching portion.

In yet another form the first and second mechanical interfaces include first and second guide portions respectively wherein the first and second guide portions are configured to align the electrical device and the charger for connection therebetween.

In yet another form the first and third mechanical interfaces include first and third guide portions respectively wherein the first and third guide portions are configured to align the electrical device and the accessory for connection therebetween.

In one form, the electrical device includes an integral power storage device.

The power storage device may include an ultracapacitor.

In one form, the electrical device is an electrical appliance. In another form, the electrical device is a hand-held power tool.

In yet another form, the electrical device is a hand-held power screw-driver.

In one form, the accessory includes an electric light.

### BRIEF DESCRIPTION OF THE DRAWINGS

It will be convenient to hereinafter describe the invention in greater detail by reference to the accompanying drawings which show preferred embodiments of the invention. The particularity of the drawings and the related detailed description is not to be understood as superseding the generality of the preceding broad description of the invention.

FIG. 1 illustrates a perspective view of an electrical device in the form of a rechargeable hand-held power screw-driver.

FIG. 2 illustrates a perspective view of a charger for charging the electrical device of FIG. 1.

FIG. 3 illustrates a perspective view of an accessory in the form of an electric light that is configured for attachment to the electrical device of FIG. 1.

FIG. 4 illustrates a perspective view of the electrical device and charger of FIGS. 1 and 2 wherein the electrical device is mated with the charger for recharging the electrical device.

FIG. 5 illustrates a schematic view of the electrical device of FIG. 1 and the charger of FIG. 2.

FIG. 6 illustrates a perspective view of the accessory of FIG. 3 connected to the electrical device of FIG. 1.

FIG. 7 illustrates another perspective view of the accessory of FIG. 3 connected to the electrical device of FIG. 1.

FIG. 8 illustrates a perspective view of another electrical device in the form of a hand-held power screw-driver in accordance with another embodiment of the invention.

FIG. 9 illustrates a perspective view of a charger configured for attachment to the electrical device of FIG. 8.

FIG. 10 illustrates a perspective view of an accessory in the form of an electric light configured for attachment to the electrical device of FIG. 8.

FIG. 11 illustrates a perspective view of the accessory of FIG. 10 attached to the electrical device of FIG. 8.

FIG. 12 illustrates a perspective view of the accessory of FIG. 10 attached to the electrical device of FIG. 8.

### DETAILED DESCRIPTION

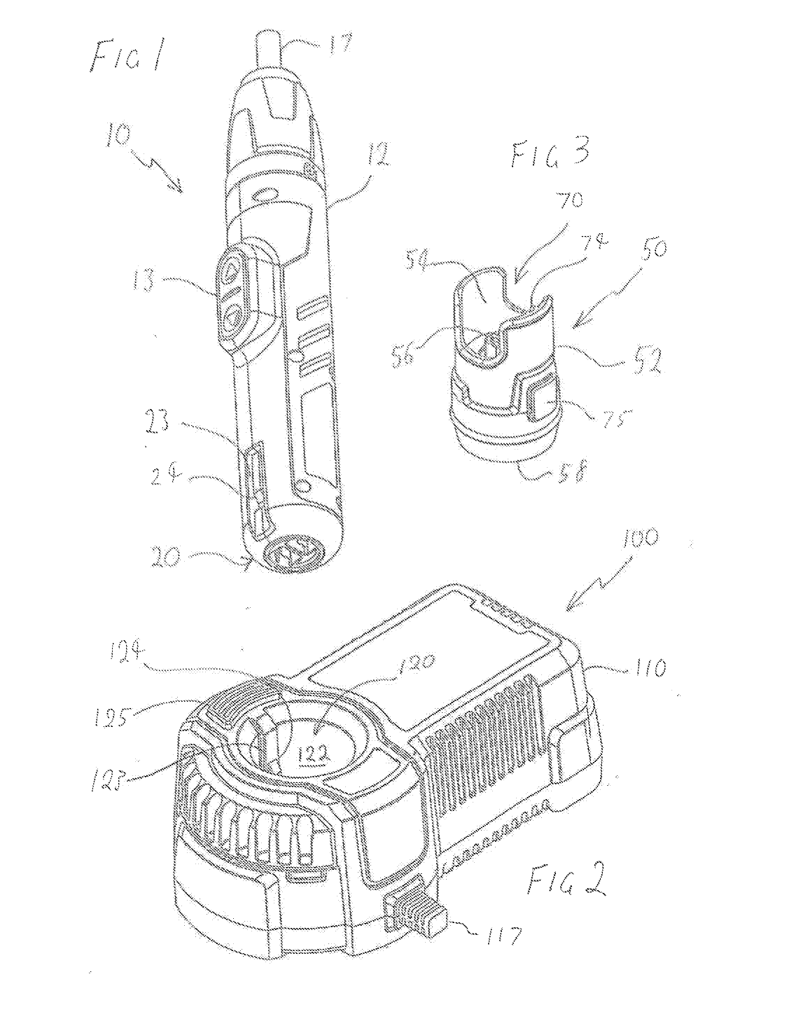

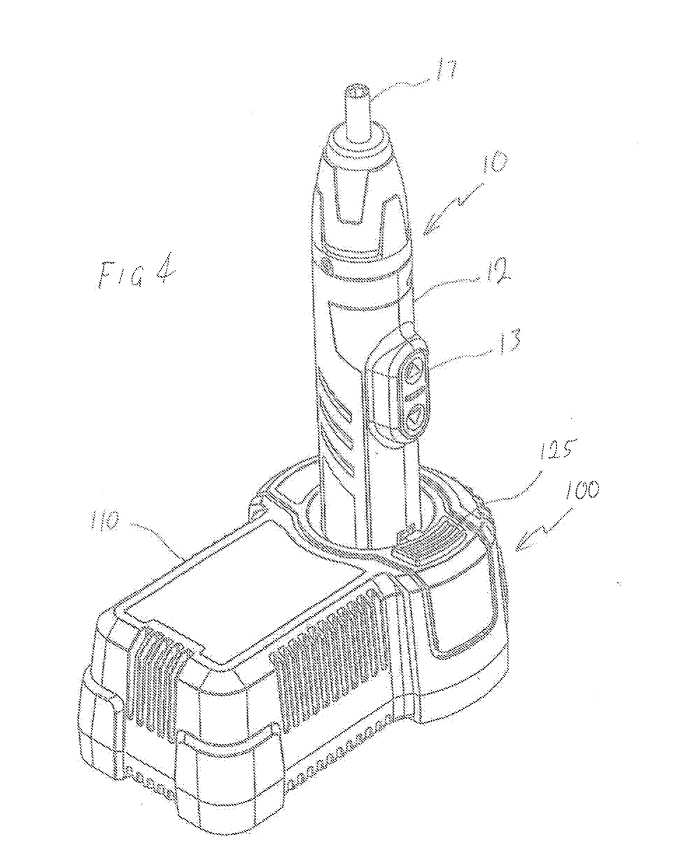

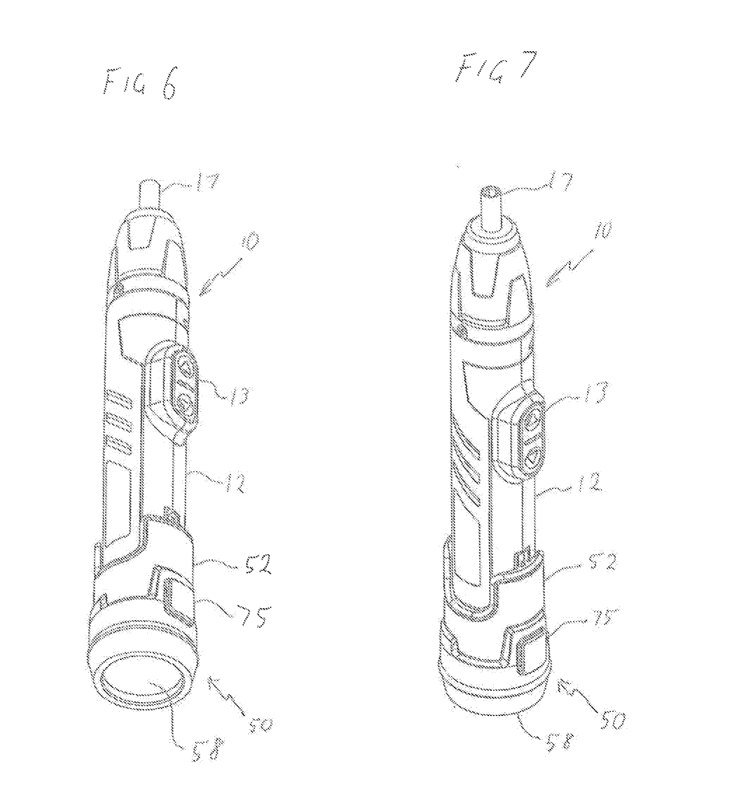

Referring to FIGS. 1 and 6 there is illustrated an electrical device in the form of a hand-held power screw-driver 10. The screw-driver 10 includes a housing 12, a switch 13, an output shaft 17 and a first connection portion 20. FIGS. 2, 4 and 5 illustrate a charger 100. The charger 100 includes a second connecting portion 120. The second connecting portion 120 is configured to mate with the first connecting portion 20 of the power screw-driver 10 in the manner illustrated in FIG. 4 and described in more detail below. FIGS. 3 and 7 illustrate an accessory 50 which includes the functionality of an electric light. The accessory 50 includes a third connecting portion 70 that is configured to mate with the first connecting portion 20 of the powered screw-driver 10. As will be described in more detail below, the first connecting portion 20 of the screw-driver 10 is configured to connect to the second connecting portion 120 of the charger 100 to enable the charger 100 to recharge the power screw-driver 10 when required. Furthermore, the first connecting portion 20 of the power screw-driver 10 is configured to mate with the third connecting portion 70 of the accessory 50 to enable the power screw-driver 10 to supply power to the accessory 50.

Although in the embodiments illustrated in the Figures the electrical device is a powered screw-driver 10, it is to be appreciated that the electrical device may take any other suitable form such as a power tool including a power drill, power sander and so on. Furthermore, although the accessory 50 illustrated in the Figures is in the form of an electric light accessory, it is to be appreciated that the accessory 50 may include any other device requiring electrical power to function.

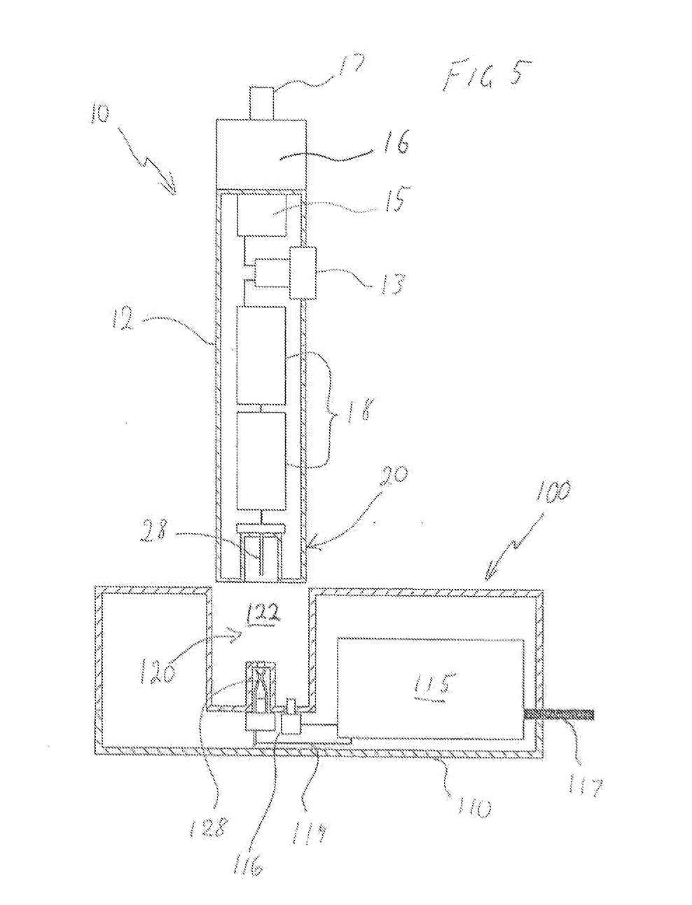

Referring to FIGS. 2, 4 and 5, the charger 100 includes a housing 110 containing a transformer and control device 115. The transformer and control device 115 receives power from an external power supply such as a mains power supply via an electrical cord 117. The transformer and control device 115 supplies power via an outlet wire 119 to a second electrical contact 128 associated with the second connecting portion 120. The second electrical contact 128 is positioned within a recess 122 formed within the housing 110. The recess 122 is shaped to receive the first connecting portion 20 of the power screw-driver 10 as shown in FIG. 4. The first connecting portion 20 includes a first electrical contact 28 which is configured to engage with the second electrical contact 128 when the first connecting portion 20 is received within the recess 122 of the second connecting portion 120 of the charger 100. In the embodiment illustrated in FIGS. 1 and 5, the first electrical contact 28 is in the form of a pin made out of an electrically conductive material and the second electrical contact 128 is in the form of a clamping mechanism formed also out of an electrically conductive material. However, it is to be appreciated that the form of the first electrical contact 28 and the second electrical contact 128 may take any suitable form that enables electrical power to be conducted from the charger 100 to the power screw-driver 10.

FIG. 5 illustrates a schematic view of the power screw-driver 10 and the charger 100. The power screw-driver 10 includes a motor 15 and a power storage device 18 in the form of a pair of ultracapacitors contained within the housing 12. The switch 13 is arranged on the outside of the housing 12 to enable a user to operate the switch 13 to control the supply of power from the power storage device 18 to the motor 15 when the power screw-driver 10 is in use. The motor 15 is connected via a gearbox 16 to the output shaft 17. The gearbox 16 can take any suitable form and may include, for example, a planetary gearbox or a parallel shaft gearbox. The purpose of the gearbox is to transmit rotation provided from the motor 15 to the output shaft 17. In doing so, the gearbox 16 causes the output shaft 17 to rotate at a different speed of rotation relative to the speed of rotation from the motor 15 at a predetermined ratio by employing a predetermined gear ratio. In one form, the gearbox 16 causes the output shaft 17 to rotate at a slower speed of rotation than the speed of rotation of the motor 15 such that the amount of torque applied to the output shaft 17 is greater than the amount of torque from the motor 15. The output shaft 17 extends from the housing 12 and is configured for attachment with a screw-driver bit (not shown).

As can be appreciated, when the power within the power storage device 18 is used up as a result of use of the power screw-driver 10 the first connecting portion 20 of the power screw-driver 10 can be mounted to the second connecting portion 120 of the charger 100 to facilitate the flow of electrical power from the charger 100 to recharge of the power storage device 18 of the power screw-driver 10. The charger 100 further includes a switching mechanism 116 which is responsive to the insertion of the first connecting portion 20 of the power screw-driver 10 into the recess 122 of the second connecting portion 120 to initiate the supply of power from the transformer and control device 115 via the second electrical contact 128 and the first electrical contact 28 to the power storage device 18.

When it is required to use the power screw-driver 10 the first connecting portion 20 of the power screw-driver 10 is disconnected from the second connecting portion 120 of the charger 100. A user can then transport the power screw-driver 10 to a location remote from the charger 100 for use thereof. If required, a user can connect the accessory 50 to the power screw-driver 10 if the user requires the functionality of the accessory 50 in addition to, or instead of, the functionality of the power screw-driver 10. To achieve this, the accessory 50 has a housing 52 which includes a recess 54 that is shaped to receive the first connecting portion 20 of the power screw-driver 10 similar to the way in which the recess 122 of the charger 100 receives the first connecting portion 20 of the power screw-driver 10. The accessory 50 includes a third electrical contact 56 which is located within the recessed portion 54 of the housing 52 of the accessory 50. The third electrical contact 56 may be of a similar type to the second electrical contact 128 of the charger 100. Accordingly, the third electrical contact 56 may be a clamping arrangement formed out of electrically conductive material that is capable of receiving the pin shaped first electrical contact 28 of the power screw-driver 10. Thus, when the accessory 50 is connected to the power screw-driver 10 in the manner described above the first electrical contact 28 of the power screw-driver 10 and the third electrical contact 56 of the accessory 50 facilitate conduction of electrical power from the power storage device 18 of the power screw-driver 10 to the accessory 50.

The accessory 50 includes an electrical light (not shown) which is arranged within a light emitting portion 58 of the housing 52 that is located at an opposite end of the housing 52 to the recessed portion 54. The electric light is electrically connected to the third electrical contact 56 via a light switch 75. The light switch 75 is arranged on the outside of the housing 52 of the accessory 50 so that a user can operate the light switch 75 by hand between on and off positions whereby in the on position electrical power is conducted via the first electrical contact 28 and the third electrical contact 56 from the power storage device 18 of the power screw-driver 10 to the electric light of the accessory 50 when connected together as described above. In another form, the light switch 75 may have a plurality of settings. Each setting may correspond to different power settings or to different light intensity settings where the accessory 50 is of the type which includes an electric light. The light emitting portion 58 may include a single light source or a plurality of light sources. Thus, selecting different settings of the light switch 75 can result in different light intensity settings by being configured to supply varying voltages, currents or both to one or more light sources. In another form, selecting different settings of the light switch 75 can result in different light intensity settings by being configured to supply or cease supply of voltage and current to a particular number of light sources associated with each setting of the light switch 75. The one or more light sources of the light emitting portion 58 may include an incandescent filament light globe, one or more light emitting diodes (LEDs), laser or ultraviolet light sources or combinations thereof.

Referring to FIGS. 1, 2 and 3, the first connecting portion 20 and the second connecting portion 120 include respective first and second latching portions 24, 124. The first and second latching portions 24 and 124 of the power screw-driver 10 and the charger 100 are configured so that when the first connecting portion 20 is inserted into the recess 122 of the second connecting portion 120, the first latching portion 24 is configured to engage the second latching portion 124 to thereby positively retain the first connecting portion 20 of the power screw-driver 10 within the recess 122 of the second connecting portion 120 of the charger 100. When the charger 100 has charged the power storage device 18 on board the power screw-driver 10 a user can remove the power screw-driver 10 from the charger 100 by depressing a release button 125 which disengages the second latching portion 124 from the first latching portion 24 to release the power screw-driver 10 from the charger 100.

As mentioned above, the first connecting portion 20 of the power screw-driver 10 is inserted into the recess 54 of the third connecting portion 70 of the accessory 50 to facilitate a connection between the first electrical contact 28 and the third electrical contact 56. The third electrical contact 56 is a clamping arrangement formed out of electrically conductive material that is capable of receiving the pin shaped first electrical contact 28 of the power screw-driver 10. The clamping force applied by the third electrical contact 56 to the first electrical contact 28 is sufficient to retain the power screw-driver 10 and the accessory 50 together. The third electrical contact 56 may be formed out of a pair of opposing, resiliently deflectable members that are configured to deflect upon receiving the first electrical contact 28 therebetween.

Although not shown in the figures the third connecting portion 70 of the accessory 50 may include a third latching portion. The third latching portion may be a similar arrangement to the second latching portion 124 of the charger 100. Thus, when the first connecting portion 20 of the power screw-driver 10 is inserted into the recess 54 of the third connecting portion 70 the third latching portion positively engages the first latching portion 24 to retain the accessory 50 together with the power screw-driver 10. The accessory 50 may also include a release button (not shown) that when depressed disengages the third latching portion and the first latching portion 24 to enable the power screw-driver 10 to be separated from the accessory 50.

In the arrangements illustrated in FIGS. 1 to 7 the first connecting portion 20 and the second connecting portion 120 include respective first and second guide portions 23, 123. The first guide portion 23 is in the form of an elongate recess in the housing 12 of the power screw-driver 10. The second guide portion 123 is in the form of an elongate protrusion within the recess 122 of the charger 100. When the first connecting portion 20 of the power screw-driver 10 is inserted into the second connecting portion 120 of the charger 100 the second guide portion 123 is received into the first guide portion 23 to thereby align the power screw-driver 10 and the charger 100 to facilitate connection between first electrical contact 28 and the second electrical contact 128.

The third connecting portion 70 of the accessory 50 includes a third guide portion 74 in the form of an elongate protrusion within the recess 54 of the third connecting portion 70. When the first connecting portion 20 of the power screw-driver 10 is inserted into the third connecting portion 70 of the accessory 50 the third guide portion 74 is received into the first guide portion 23 to thereby align the power screw-driver 10 and the accessory 50 to facilitate connection between first electrical contact 28 and the third electrical contact 56.

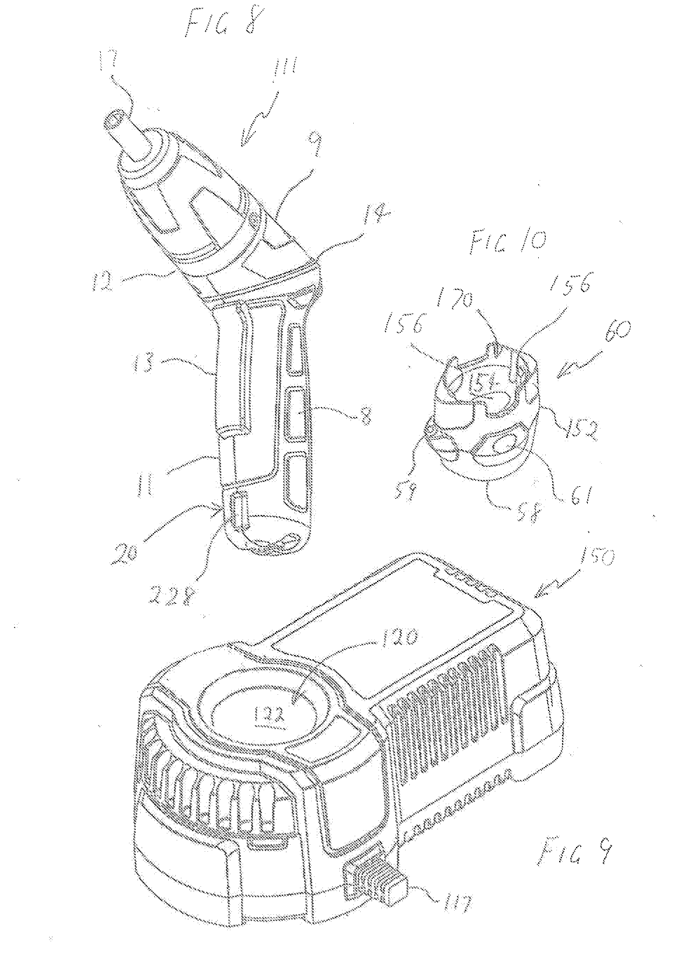

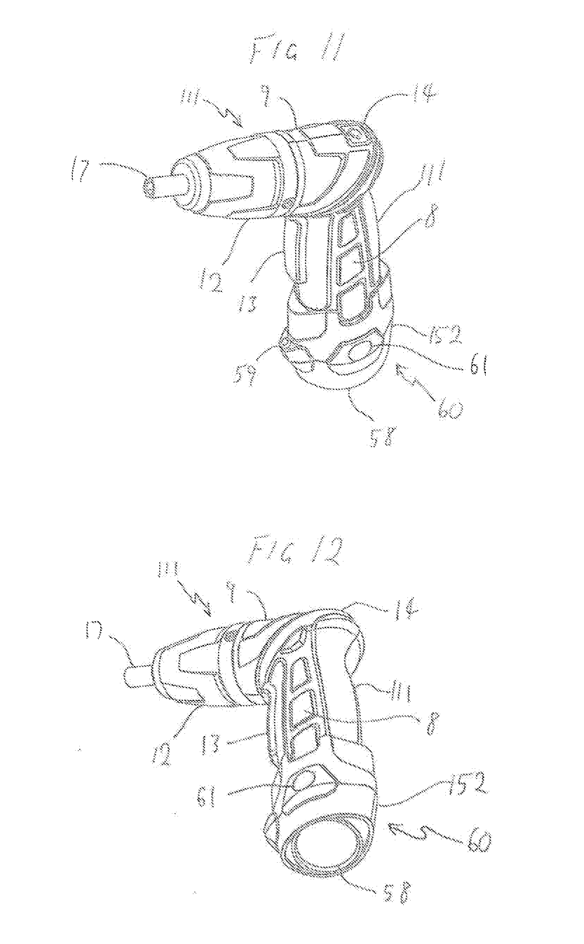

Referring to FIGS. 8 to 12 there is shown another Embodiment of the Invention. Like references numerals are used for like features in relation to the embodiments illustrated in FIGS. 1 to 7 and 8 to 12. The embodiment of FIGS. 8 to 11 includes a power screw-driver 111, a charger 150 and an accessory 60. The power screw-driver 111 of FIGS. 8, 11 and 12 includes a housing 12 made up of a first housing portion 9 and a second housing portion 11 wherein the first housing portion 9 and the second portion 11 are pivotally connected about a pivot connection 14 therebetween. The pivot connection 14 enables the first housing portion 9 to pivot relative to the second housing portion 11 between a pistol like configuration as illustrated in FIGS. 8, 11 and 12 and a linear configuration similar to the arrangement of the power screw-driver 111 illustrated in FIGS. 1, 4, 5, 6 and 7. Furthermore, the switch 13 of the power screw-driver 111 is in the form of a trigger which is arranged adjacent to an exterior gripping surface 8 of the second housing portion 11.

Similar to the embodiment illustrated in FIGS. 1 to 7 described above, in the embodiment illustrated in FIGS. 8 to 12, the first connecting portion 20 of the power screw-driver 111 is configured to be received within the recess 122 of the second connecting portion 120 of the charger 150. However, unlike the embodiment illustrated in FIGS. 1 to 11, the embodiment illustrated in FIGS. 8 to 12 does not include first and second latching portions 24 and 124 associated with the power screw-driver 111 and the charger 150. Furthermore, the first electrical contacts 228 of the power screw-driver 111 are not arranged in the form of pins but rather are plates that are arranged in the lateral side portions of the second housing portion 11 at the connecting portion 20 thereof. The second electrical contacts (not shown) of the charger 150 are arranged as flat plates disposed in the lateral sides of the recess 122 at the lower portion thereof so that they make contact with the first electrical contacts 228 of the power screw-driver 111 when the first connecting portion 20 is inserted within the recess 122 of the second connecting portion 120 of the charger 150.

When the charger 150 has charged the power storage device 18 located on board the power screw-driver 111 a user can remove the power screw-driver 111 from the charger 150 and attach a screw-driver bit to the driven member 17 and operate the trigger 13 to drive screws into a work piece. Furthermore, the embodiment illustrated in FIGS. 8 to 12 includes another form of the accessory 60 which also includes a housing 152, a third connecting portion 170 with third electrical contacts 156 disposed within a recess 154. The third electrical contacts 156 are in the form of flat plates that are disposed on the lateral surfaces defining the recess 154 within the housing 152. Thus, when the first connecting portion 20 of the power screw-driver 111 is inserted into the recess 154 of the accessory 60 the first electrical contacts 228 come into contact with the third electrical contacts 156. Contact between the first electrical contacts 228 and the third electrical contacts 156 enables electrical power to be conducted from the power storage device 18 on board the power screw-driver 111 to the accessory 60 and the light emitting portion 58 which is disposed in the housing 152 opposite to the recess 154.

The third electrical contacts 156 of the accessory 60 may be disposed on opposing lateral surfaces defining the recess 154 within the housing 152. Thus, when the first connecting portion 20 of the power screw-driver 111 is inserted within the recess 154 of the third connecting portion 170 of the accessory 60 the third electrical contacts of the accessory 156 clamp the first electrical contacts 228 of the power screw-driver 111 therebetween in order to help retain the power screw-driver 111 and the accessory 60 together. To achieve the clamping action the third electrical contacts 156 of the accessory 60 may be formed in a manner that enables them to resiliently deflect when the first connecting portion 20 of the power screw-driver 111 is inserted within the recess 122 of the third connecting portion 70 of the accessory 60 and the first electrical contacts 228 of the power screw-driver 111 are received between the third electrical contacts 156 of the accessory 60.

The accessory 60 includes a switch 61 which enables the light emitting portion 58 to be turned on and off. Furthermore, the accessory 60 includes a second light emitting portion 59 which may be one or more light emitting diodes (LED), a laser light source or an ultraviolet light source which is arranged to direct light towards the driven member 17 of the power screw-driver 111 to cast light on the screw or the work piece when the power screw-driver 111 is in use. The second light emitting portion 59 of the embodiment illustrated in FIGS. 8 to 12 is configured to be operable when the first housing portion 9 is pivoted relative to the second housing portion 11 to the pistol like configuration as illustrated in FIGS. 8, 11 and 12 to direct light towards the driven member 17 of the power screw-driver 111 to cast light on the screw or the work piece when the power screw-driver 111 is in use.

In the embodiments illustrated in the Figures the power storage device 18 is located on board and is integral with the power screw-driver 10, 110. To achieve this, the power storage device 18 is positioned within the housing 12 of the power screw-driver 10 illustrated in FIGS. 1 to 7 and within the second housing portion 11 of the power screw-driver 111 illustrated in FIGS. 8 to 12. Accordingly, the power storage device 18 is integral with the power screw-driver 10, 110. In preferred forms of the invention, the power storage device 18 is in the form of one or more ultracapacitors only. Such ultracapacitors may include any one or more electric double-layer capacitors (EDLC), pseudocapacitors or the like. However, it is to be appreciated that the power storage device 18 may include one or more rechargeable batteries of any other suitable form. Further, the power storage device 18 may include a combination of electric double-layer capacitors (EDLC), pseudocapacitors, and rechargeable batteries. Furthermore, the power storage device 18 may be configured to remain permanently connected to the power screw-driver 10, 110 or it may be configured to be removable from the power screw-driver 10, 110.

Although in the embodiments illustrated in the Figures, the electrical device is a hand-held power screw-driver 10, 110, it is to be appreciated that the electrical device may be in the form of a household electrical appliance or any other portable electrical device such as an electromechanical device. Thus, the electrical device may include hand held electrical appliances for personal use such an electric toothbrushes, shavers and the like. Alternatively, the electrical device may be another type of power tool other than a powered screw-driver such as a hand-held power drill, power sander or the like. Furthermore, although the accessory 50, 60 illustrated in the figures is in the form of an accessory 50, 60 incorporating either a single light source in the form of the light emitting portion 58 or more than one light source in the form of the light emitting portion 58 in conjunction with a second light emitting portion 59, it is to be appreciated that the accessory 50, 60 may include other types of electrically powered devices such as a laser light source, a sound emitting device such as a radio, an electromechanical device or combinations thereof.

An advantage of the invention, as described in detail above, is that it provides a rechargeable hand-held electrical device which can be recharged by a charger to perform the ordinary function associated with the device and also provides an accessory which can be attached to the device to undertake one or more additional functions without the need for an entirely separate power storage device associated with the accessory alone. Another advantage of the invention is that the same connecting portion associated with the device is utilised to connect the device with the charger to recharge the device and to connect with the accessory to provide electrical power to the accessory.

Those skilled in the art will appreciate that the invention described herein is susceptible to variations and modifications other than those specifically described. It is to be understood that the invention includes all such variations and modifications which fall within the spirit and scope of the invention.

Future patent applications may be filed in Australia or overseas on the basis of, or claiming priority from, the present application. It is to be understood that the following provisional claims are provided by way of example only and are not intended to limit the scope of what may be claimed in any such future application. Features may be added to, or omitted from, the provisional claims at a later date so as to further define or re-define the invention or inventions.

1. An accessory and charging system for a rechargeable hand-held electrical device, the system including an electrical device for performing at least one electrically powered primary function, a separate accessory for performing at least one electrically powered secondary function and a charger, wherein the electrical device includes a power storage device and a first connecting portion, the charger includes a second connecting portion and the accessory includes a third connecting portion, wherein the first connecting portion of the electrical device is configured to mate with the second connecting portion for enabling the charger to recharge the power storage means of the electrical device and with the third connecting portion for enabling the power storage means of the electrical device to supply power to the accessory to perform the at least one secondary function, wherein the electrical device performs the at least one primary function when the first connecting portion is free to mate with either the second or third connecting portions.

2. The system of claim 1, wherein when the first connecting portion of the electrical device is mated with the third connecting portion of the accessory, the electrical device performs the at least one primary function and supplies power to the accessory to perform the at least one secondary function.

3. The system of claim 1, wherein the first, second and third connecting portions include first, second and third electrical contact respectively and the first electrical contact is configured to engage with the second electrical contact for conducting electrical power from the charger to the electrical device and with the third electrical contact for conducting electrical power from the electrical device to the accessory.

4. The system of claim 1, wherein the first, second and third connecting portions include first, second and third mechanical interfaces respectively and the first mechanical interface is configured to engage with the second mechanical interface for connecting the charger and the electrical device and to engage with the third mechanical interface for connecting the electrical device and the accessory.

5. The system of claim 4, wherein the first and second mechanical interfaces include first and second latching portions respectively wherein the first latching portion is configured to engage the second latching portion.

6. The system of claim 4, wherein the first and third mechanical interfaces include first and third latching portions respectively wherein the first latching portion is configured to engage the third latching portion.

7. The system of claim 4, wherein the first and second mechanical interfaces include first and second guide portions respectively wherein the first and second guide portions are configured to align the electrical device and the charger for connection therebetween.

8. The system of claim 4, wherein the first and third mechanical interfaces include first and third guide portions respectively wherein the first and third guide portions are configured to align the electrical device and the accessory for connection therebetween.

9. The system of claim 1, wherein the power storage device is integral with the electrical device.

10. The system of claim 1, wherein the power storage device includes an ultracapacitor.

11. The system of claim 1, wherein the electrical device is an electrical appliance and the at least one electrically powered primary function is a powered appliance function.

12. The system of claim 1, wherein the electrical device is a hand-held power tool and the at least one electrically powered primary function is a powered tool function.

13. The system of claim 1, wherein the electrical device is a hand-held power screwdriver and the at least one electrically powered primary function is a powered screw-driving function.

14. The system of claim 1, wherein the electrically powered secondary function of the accessory includes a powered function of any one or more of an electrically powered light source, a sound emitting device, an electromechanical device or combinations thereof.

15. The system of claim 1, wherein the electrically powered secondary function of the accessory includes a powered function of a light emitting diode or a laser or a combination thereof.
